(19) United States
(12) Patent Application Publication
(10) Pub. No.: US 2021/0182430 A1
(43) Pub. Date: Jun. 17, 2021

(54) METHODS AND SYSTEMS OF ENABLING SENSIVITE DOCUMENT SHARING IN COLLABORATIVE SESSIONS

(71) Applicant: Avaya Inc., Santa Clara, CA (US)

(72) Inventors: Manish Negi, Pune (IN); Sujata Anand Gole, Pune (IN); Divakar Kumar Ray, Pune (IN)

(21) Appl. No.: 16/714,376

(22) Filed: Dec. 13, 2019

(51) Int. Cl. G06F 21/62; G06N 3/08; G06F 16/176

(52) U.S. Cl. CPC G06F 21/6263; G06F 21/6254; G06F 16/176; G06N 3/08

(57) ABSTRACT

Embodiments described herein provide systems and methods for automatically censoring sensitive data from a shared document in a collaborative document-sharing session. Methods and systems include receiving, by a processor of a computer system executing an application participating in the collaborative document-sharing session, a document to upload to the session. Methods and systems include analyzing a plurality of portions of the document. Methods and systems include based on the analysis of the plurality of portions, identifying a first one or more of the portions of the document containing sensitive information. Methods and systems include using an artificial intelligence system to identify sensitive information contained within the documents. Methods and systems include modifying a copy of the document to block the first one or more of the portions of the document containing sensitive information. Methods and systems include displaying the modified copy of the document in the collaborative document-sharing session.

### FIELD

The present disclosure is generally directed to collaboration software systems and, in particular, toward methods of sharing documents in cobrowsing sessions.

### BACKGROUND

Cobrowsing applications are increasingly becoming more important tools within collaborative environments. Cobrowsing applications enable multiple users view and/or navigate Internet webpages or other Internet resources. Using cobrowsing applications, several users can view a webpage simultaneously while participating in a collaboration session. For example, users participating in a conference call may find a need to view a webpage together. A first user on the conference call can open a webpage in a cobrowsing application. Other users on the conference call can join the cobrowsing application and view the webpage with the first user.

Cobrowsing applications can take the form of a web application which executes inside an Internet browser. These cobrowsing applications are typically initiated from a special Uniform Resource Locator (URL) associated with the cobrowsing application. The URL can initialize the cobrowsing application and enable synchronized navigation within the cobrowsing application to occur.

A benefit of cobrowsing applications as opposed to simple screensharing applications is increased privacy. Users do not need to worry about other applications running on their computers before beginning a cobrowsing application. For example, a user with an Excel file containing sensitive information can keep the Excel file open during the cobrowsing application without the risk of the content of the Excel file being disclosed during the collaborative session.

However, users may on occasion have a need to share documents and/or webpages containing sensitive information. For example, the user with the Excel file containing sensitive information may desire to share contents of the Excel file without disclosing the sensitive information contained within. Conventional web cobrowsing applications do not have ability to enable users to share documents and/or webpages containing sensitive information without disclosing the sensitive information.

### BRIEF DESCRIPTION OF THE DRAWINGS

FIG. 1 shows a computer network environment in accordance with one or more of the embodiments described herein;

FIG. 2 shows a computer system in accordance with one or more of the embodiments described herein;

FIGS. 3A-3I are diagrams of embodiments of graphical user interfaces (GUIs) in accordance with one or more of the embodiments described herein;

FIG. 4 is a diagraph of an embodiment of a GUI in accordance with one or more of the embodiments described herein;

FIG. 5 is a flow chart of a process in accordance with one or more of the embodiments described herein;

FIG. 6 is a flow chart of a process in accordance with one or more of the embodiments described herein; and

FIG. 7 is a flow chart of a process in accordance with one or more of the embodiments described herein.

### DETAILED DESCRIPTION

While cobrowsing is a beneficial application, cobrowsing is limited in its ability for users to share documents. In conventional cobrowsing applications, users cannot adequately collaborate on non-HTML documents such as Word and Excel documents. Embodiments of the present disclosure describe how webpages and/or documents containing sensitive information may be shared during an active web collaboration without disclosing the sensitive information contained therein.

In certain embodiments of the disclosure, a transformer available in web application can dynamically convert a document or webpage to be shared in a cobrowsing application into a masked copy in which any sensitive information is blocked from view.

Further, with the aid of artificial intelligence (“AI”), a cobrowsing application may be capable of automatically identifying any sensitive information in a webpage or document to be shared. A cobrowsing application may be capable of automatically blocking such sensitive information by creating a mask. Users may be enabled to add or remove portions of a mask to block or unblock information from the webpage or document.

Contemporary web conferencing and/or collaboration solutions do not restrict the sharing of single or multiple portions of a shared application, webpage, or document. Contemporary solutions do not provide for participants to dynamically indicate content which should not be shared with other participants for a shared document, webpage, or application. For example, during an active session, if a participant wants to share some dynamically picked document but the document contains some critical information which should not be shared with other participants, contemporary solutions do not provide for restricting the content of the document from the audience. Contemporary solutions do not provide participants the ability to specify which specific content or section of the shared webpage or document should be shared or should not be shared with the audience. For example, contemporary solutions do not provide provisions to tag or annotate content or portions of a webpage or document such that the specified tagged contents may be hidden or masked for other participants. Similarly, contemporary solutions do not provide provisions for dynamically hiding contents of a shared document or webpage. In web-conference sessions, participants are allowed to share an application, document, or webpage to other parties. However, contemporary conferencing solutions do not provide provisions allowing participants to specify which content or portion or multiple portions of a shared document, application, or webpage, not to be shared with other participants before sharing the document, application, or webpage during a live conference.

Due to the above-discussed limitations of conventional cobrowsing applications, cobrowsing is not as useful a tool as required by contemporary computer users. What is needed is a way for users to be capable of sharing documents and/or webpages containing sensitive information in a cobrowsing application without displaying such sensitive information and without requiring additional software applications. Furthermore, what is needed is a way to automatically and dynamically mask documents, webpages, applications, etc. during active cobrowsing sessions.

Embodiments of the present disclosure will be described in connection with a computer-implemented method for enabling document sharing in a cobrowsing session. In some embodiments, a method for automatically censoring sensitive data from a shared document in a collaborative document-sharing session may comprise performing operations as follows on a processor of a computer system executing an application participating in the collaborative document-sharing session: receiving a document to upload to the session; analyzing, by the processor, a plurality of portions of the document; based on the analysis of the plurality of portions, identifying, by the processor, a first one or more of the portions of the document containing sensitive information; modifying, by the processor, a copy of the document to block the first one or more of the portions of the document containing sensitive information; and displaying, by the processor, the modified copy of the document in the collaborative document-sharing session. Such operations may be as described in greater detail below.

For example, suppose a user is using a cobrowsing application to speak with a customer support agent about a credit card bill. The user would like help with a webpage which includes credit card information. The user may be capable of previewing the webpage before sharing the webpage, selecting and/or having selected by an AI one or more portions of content on the webpage the user would not like to share with the agent, and having an edited or otherwise modified version of the webpage shared in the cobrowsing application.

As another example, suppose two users of a cobrowsing application are discussing business. One user would like to share sales data without disclosing certain numbers. The user may, prior to having a document with the sales data shared, preview the document, select and/or having selected by an AI one or more portions of content on the document the user would not like to share with the other user, and having an edited or otherwise modified version of the document shared in the cobrowsing application.

In this way, documents, webpages, applications, etc. may be annotated to be marked up such that sensitive data and/or any data the sharing party does not want to be shared can be removed, covered, etc. The data may be marked in a way that is clear that there is data being hidden, for example a black box, or may be removed such that it is not clear there was data not being shared.

When a user seeks to share a document, an AI system may propose portions of the document which should not be shared with the other party. After the AI system proposes portions of the document which should not be shared, the user seeking to share the document may have a capability to review the proposed portions. The user may be capable of adding additional portions of content to the proposed portions or removing some portions from the proposed portions. When this happens, the AI system may be capable of learning from the review of its initial suggestion to aid in its suggestions in later document analysis.

By having an AI-assisted document review process, the proposed systems and methods provide users a simple way to share documents which may or may not contain sensitive information. Users can share even the most secure documents without hesitation knowing that the documents will undergo a two-part review to block sensitive data.

An AI data model may be trained on what other people are choosing to block out based on the basis of prior experience. For example, a model may be created on the basis of how many times a customer identifies a particular portion before sharing a document. For example, a user sharing a document, which is unrelated to a currently trained AI system. The user may manually select portions of the document for being censored. An AI system may review what has been selected and may begin to train to identify portions similar to those portions. For example, a text block beginning with “Credit Card:” and followed by sixteen characters may be identified by the user. Another user with another document may similarly identify another text block beginning with “Credit Card:” and followed by sixteen characters. The AI system may then learn to identify portions similar to “Credit Card:” followed by sixteen characters and will in the future suggest to a user to block such portions.

Additionally, a user sharing a document may be capable of reviewing portions identified by the AI system and may either approve or deselect certain identified portions before sharing the document.

While the description contained herein refers to the blocking of content of a shared document, it should be appreciated that such blocking of content may be performed on shared webpages, application user interfaces, and other shared content. Any discussion of blocking content of a document should be appreciated as being similarly applicable to the blocking of content of other types of visual material. While the systems and methods described herein are described in a way that relates to cobrowsing applications, it should be appreciated that the systems and methods should not be limited to just cobrowsing. The systems and methods may similarly apply to other applications involving sharing documents.

As described herein, content of a shared document may be dynamically masked either by a participant manually or by an AI system such as a neural network. In some embodiments, an AI system may make suggestions which may be approved, disapproved, or edited by a user. For example, a user may add or remove content from the AI suggested content before the content is blocked and the censored document is shared. Such blocking of content may be performed in real-time during a conference session. In some embodiments, the blocked or censored version of the document may be displayed to other users while the full, unedited document may be displayed by the user that requested the censoring. In some embodiments, the AI system may be capable of automatically blocking content without requiring human input. In this way, the masking of content is not restricted to being decided by an administrator, session participant, or other user.

Current conferencing solutions do not provide participants the ability to specify which specific content or section of the sharing document/application should not be share to the audience. Disclosed systems and methods provide a participant of a cobrowsing session an ability to tag or annotate content or portions of content which the participant does not want to be shared with other participants for any selected document before sharing the document to other participants during the live conferencing session.

When the document selected to share is previewed during a preview mode, the participant sharing the document may be allowed to use some kind of tag, annotation, or marker to specify content which should not be displayed while the document is shared in the session. The content not to be shared may be overlaid by an element such as .svg or .div tags, etc. such that the content beneath the element is not shown to other participants

In some embodiments, a system of groups may be used to manage the flow of data between users. For example, a cobrowsing session may be joined by three or more participants. Two or more of the participants may be associated with a particular entity, such as a business or family, while the remainder of the participants may be associated with one or more other entities. Those two or more participants associated with the particular entity may be logically connected as a group. When a document is to be shared by a member of the group, the cobrowsing application may either assume or ask the member whether other members of the group should be capable of seeing sensitive data within the document while participants who are not members of the group will be blocked from seeing the sensitive data.

In some embodiments, members of a group of a participant sharing a document may be capable of blocking and/or unblocking certain portions from being shared in a preview mode prior to the sharing of the document with the rest of the participants.

In some embodiments, when a document is shared with the rest of the participants, the censored version of the document may be viewed by the rest of the participants while members of the group may be capable of viewing the unedited version. In some embodiments, a GUI button may be presented to members of the group or to the sharing participant to switch between the censored and the uncensored versions of the document. Note that a button as used herein does not necessarily correspond to dedicated hardware or any type of physical button may be encompass a soft button, a selectable area in a touch-sensitive user interface, a user interface element, etc.

In some embodiments, a plurality of groups of participants may join in a cobrowsing session. Multiple groups may be linked together to share certain privileges. For example, multiple groups may join together into a single group for particular documents and may act as separate groups for other documents. A group editing user interface may be presented to users to allow each user, or a moderating user, to edit the members of each group and to edit the permission levels of each participant.

In some embodiments, the permission level for a particular document may depend on a type of document. For example, webpages may be shared by all participants while uploaded documents may be restricted to entering a preview mode to allow only the uploading participant to censor the document before sharing with the other participants.

In some embodiments, the masking may be applied in reverse such that a participant wanting to share only a selected portion of a document may select only that portion of the document which should be shared.

During use of such systems and methods as described herein, the selection by users of content not to be shared may be captured and recorded and may be used to build and train an AI data model.

Before sharing a selected document, a trained AI system may scan the document and automatically show and/or suggest to the participant which content the AI system has decided should not be shared with other participants.

Additionally, a participant may be allowed to add additional content or to remove some or all of the suggested content by the AI from the content to be censored before sharing the document.

In some embodiments, the neural network outputs a group of the portions of the document identified as containing sensitive information.

In some embodiments, prior to displaying the modified copy, the processor displays a preview of the modified copy of the document on a display device of the computer system.

In some embodiments, after displaying the preview of the modified copy, the processor waits for feedback before displaying the modified copy of the document.

In some embodiments, the neural network is trained based on the feedback.

In some embodiments, the feedback comprises a disapproval of one or more of the one or more of the portions of the document containing sensitive information.

In some embodiments, the modified copy may be modified to unblock the disapproved one or more of the one or more portions of the document containing sensitive information.

In some embodiments, the feedback comprises an indication of a second one or more of the portions of the document, wherein each of the second one or more of the portions of the document are not contained in the first one or more of the portions of the document containing sensitive information.

In some embodiments, the second one or more of the portions of the document are added to the first one or more of the portions of the document.

In some embodiments, modifying the copy of the document comprises adding a mask to the document. In some embodiments, the mask is in an SVG format.

Embodiments of the present disclosure will be described in connection with a computer-implemented method for enabling sensitive document sharing in a cobrowsing session. The computer-implemented method may be executed on one or more servers such as a webserver or may be executed on one or more personal computer devices. In some embodiments, the method may comprise initiating the cobrowsing session. For example, as discussed herein, initiating the cobrowsing session may involve users sharing a URL to a webpage in which a cobrowsing application may be initiated. In some embodiments, a cobrowsing session may involve using an application executing on a personal computer system. One or more participants to the cobrowsing session may log into such an application and join the session.

In some embodiments, the method may comprise generating a GUI of the cobrowsing session configured to display on a user device. For example, a GUI may be presented within a web-based application executing in a browser or may be presented within a window of a cobrowsing application executing on a user device. The GUI may present options for participants of the cobrowsing session, such as options to add participants, upload documents, edit permissions for shared documents, and other settings.

These and other operations may be as described in greater detail below.

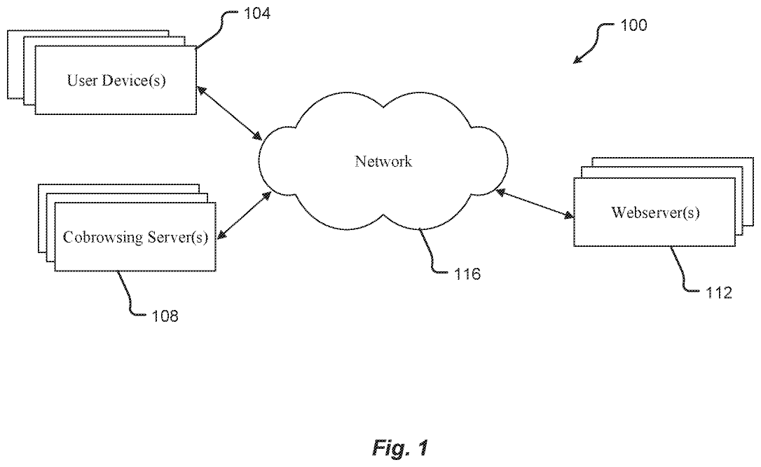

In some embodiments, a computer-implemented method for executing a cobrowsing session may execute in an environment 100 including one or more user device(s) 104, one or more cobrowsing server(s) 108, and/or one or more webserver(s) 112 connected via a network 116 as illustrated in FIG. 1. By interconnecting one or more user device(s) 104, one or more cobrowsing server(s) 108, and/or one or more webserver(s) 112 via a network 116, a cobrowsing session may be implemented allowing users of the user device(s) 104 to via a cobrowsing GUI.

User device(s) 104 may in some embodiments comprise personal computers, laptops, tablet devices, smartphones, or any other type of device capable of executing a cobrowsing application or Internet browser. In some embodiments, a cobrowsing session may be executed within a browser window such as Internet Explorer™, Google™ Chrome™, Firefox™, etc. and may be implemented using a Javascript™ application.

The environment 100 may comprise one or more cobrowsing server(s) 108. Cobrowsing servers 108 may be dedicated servers configured to host one or more cobrowsing sessions for a multitude of users. It should be noted that dedicated cobrowsing servers 108 should not be considered as required by certain embodiments. For example, either of a webserver 112 and/or a user device 104 may be capable of hosting a cobrowsing session.

Webserver(s) 112 may comprise network connected computer systems hosting one or more webpages. Information hosted on webservers 112 may be accessed during cobrowsing sessions and may be displayed in GUI elements on one or more user devices via browser windows.

A cobrowsing server 108 and/or webserver 112 can be or may include any server that is capable of executing a cobrowsing session between two or more user devices 104 to view web pages provided by a webserver 112.

The web server 130 can be or may include any software/hardware that can work with the user devices 104 to provide one or more web pages 131, such as Apache®, Nginx®, Microsoft-ITS®, Tomcat®, and/or the like. The web server 130 may comprise a plurality of web servers 130. For example, the web server 130 may comprise different web servers 130 from different companies, enterprises, groups, and/or the like. The web server 130 provides web page(s) 131 that can be viewed by a user running a user devices 104 on a communication endpoint.

A network 116 may be a private network, a local-area network, or a wide-area network such as the Internet. For example, a private network accessible within a corporation may host a cobrowsing system, while in some embodiments cobrowsing may take place across the Internet.

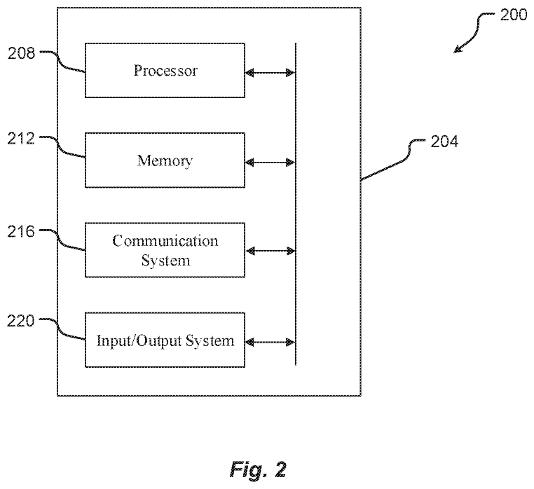

Any of the user devices 104, cobrowsing server 108, webserver 112, and/or other computer systems as described herein may be as illustrated in FIG. 2. A computer system 204 may comprise a processor 208, a memory element 212, a communication system 216, and an input/output system 220.

A processor 208 can be or may include any hardware processor, such as a Digital Signaling Processor (DSP), an application specific processor, a microcontroller, a multi-core processor, and/or the like. Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM1926EJ-S™ processors, other industry-equivalent processors, and may perform computational functions using any known or future-developed standard, instruction set, libraries, and/or architecture.

A memory element 212 may be any computer readable storage medium, such as a memory (i.e., a computer memory, a hard disk, and/or the like). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A communication system 216 can be or may include any hardware interface coupled with software that can communicate with the network 116. For example, the communication system 216 can be a wireless interface, a wired interface, a fiber optic interface, an Ethernet interface, a cellular interface, a WiFi interface, and/or the like.

An input/output system 220 can be or may include any type of hardware interface coupled with software that can communicate with a user of the computer system 200. For example, keyboard, mouse, display screen, microphone, speaker, etc.

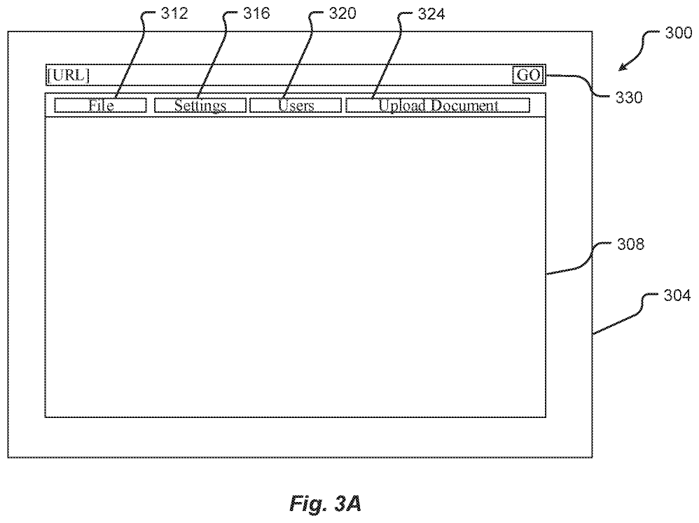

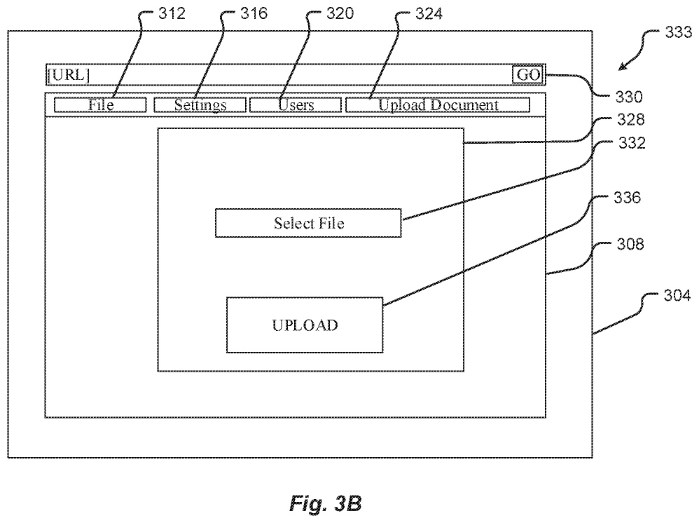

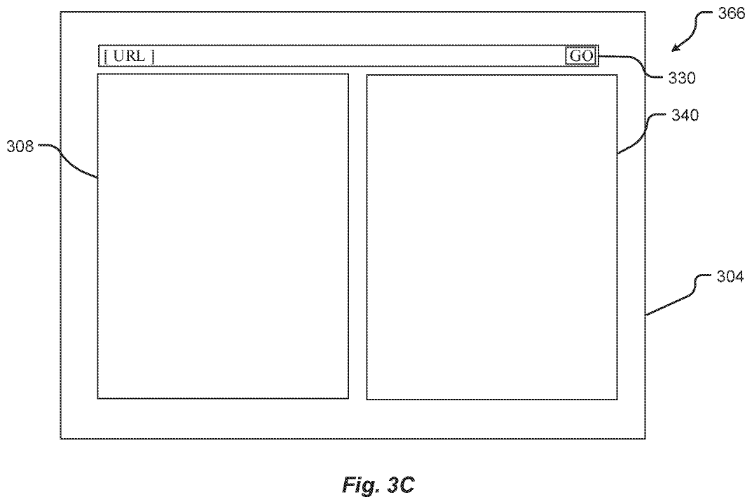

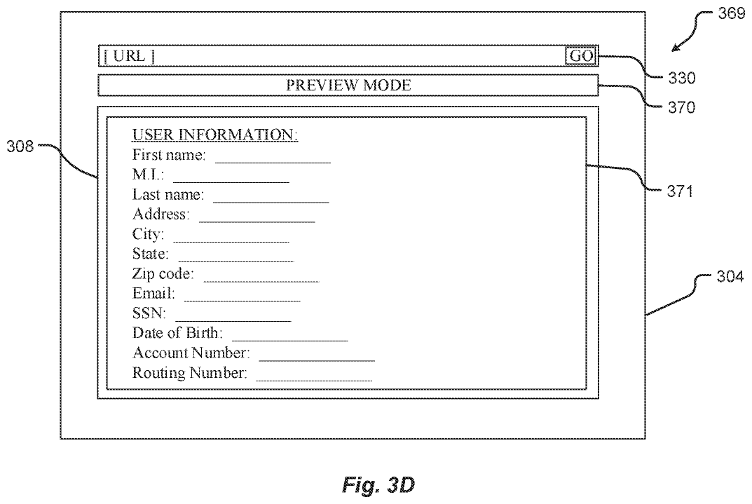

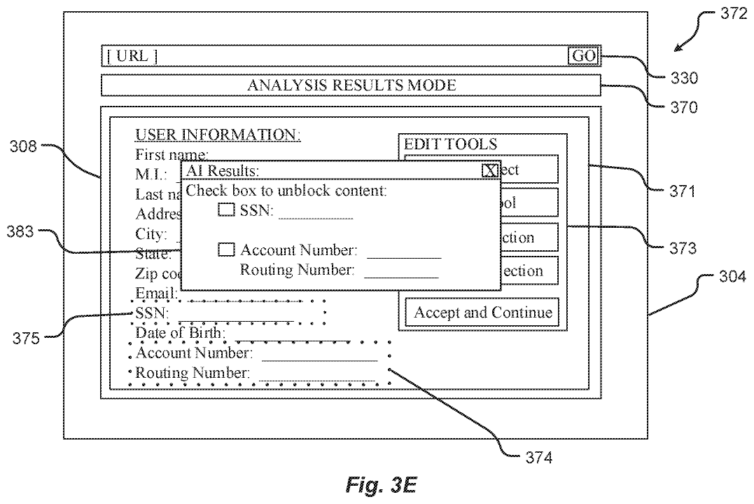

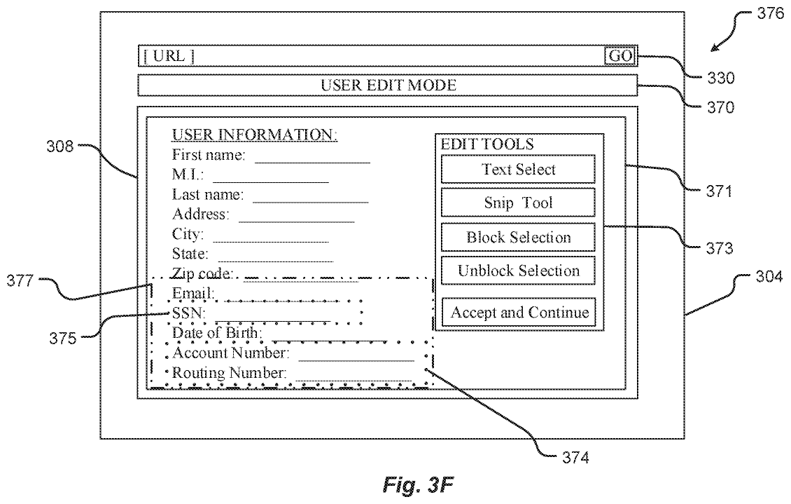

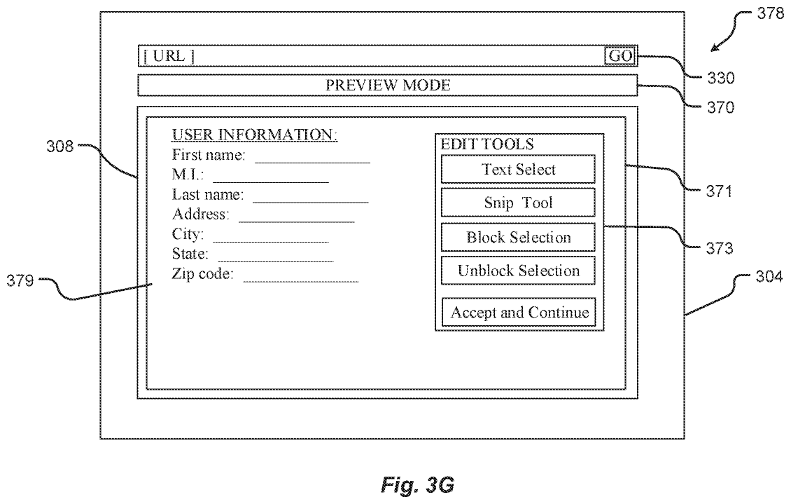

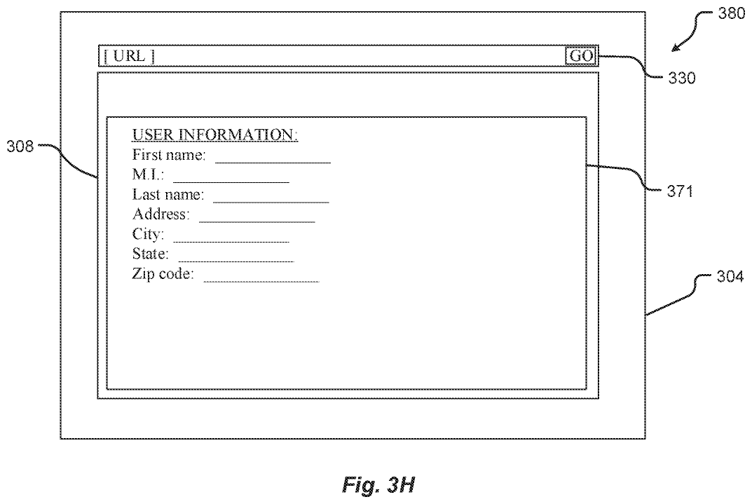

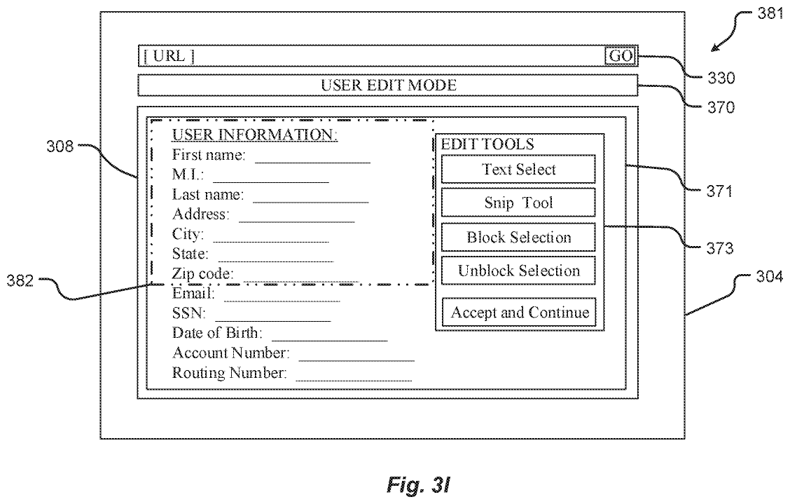

FIGS. 3A-3I are illustrations of a browser executing a cobrowsing session on a user device. The browser displays a web page uploaded from the web server. A cobrowsing session may include a java script run-time engine to interpret java script and/or HTML of a web page for view by a user in the browser.

User interface elements described herein can be or may include any type of user interface element that can be displayed/sounded by a browser such as a button, a window, a pane, panel, a menu, a menu item, an icon, a tab, a text object, a text entry object, a scroll bar, a slider, a cursor, a picture, a video, a sound object, a vibration object, and/or the like.

When a user accesses a web page using the browser, web page code may be uploaded from a webserver or other network location. For example, when the user enters a Uniform Resource Locator (URL) in the browser, code from the web page associated with the URL may be uploaded to the browser.

As illustrated in FIG. 3A, a cobrowsing session may comprise a user interface 300 displayed on one or more user devices. The user interface may include an outer window 304 containing a number of GUI elements. The outer window 304 may include a browser window 308 displaying cobrowsing material. The user interface 300 may comprise a series of GUI buttons such as a file button 312, a settings button 316, a users button 320, and/or an upload document button 324. The user interface 300 may also include a navigation bar 330 enabling users to select a URL to visit in the browser window 308.

A browser window 308 may be configured to display the contents of a webpage accessed from a network location. During a cobrowsing session, multiple users at multiple user devices 104 may share a view of the browser window 308.

A navigation bar 330 may be used to enable users to select a URL to visit in the browser window 308. Entering a URL and submitting or clicking an enter or go button may begin a downloading of contents from the URL into the browser window 308.

The outer window 304 may include a series of user interface buttons 312, 316, 320, 324 enabling users to interact with the cobrowsing session. For example, a file button 312 may present a dropdown menu providing a number of options such as exit, new window, etc. A settings button 316 may present a pop-up or modal window listing a series of options for user-customizable settings. A users button 320 may present a list of users participating in the cobrowsing session and may provide options such as adding or dropping participants, muting participants, setting permission levels for participants, etc. An upload document button 324 may begin a process of uploading a document from the user device to share in the cobrowsing session in a converted format as described herein.

As illustrated in FIG. 3B, a user interface 333 may display a document upload GUI element 328 including a select file button 332 and an upload button 336. A document upload GUI element 328 may be presented following a user selecting an upload document button 324. In some embodiments, while the browser window 308 may be presented on all participant's display devices, the document upload GUI element 328 may display only on the display of the user that selected the upload document button 324. By selecting the select file button 332, the user may be presented with a file navigation window enabling the user to select a file to upload and share in the cobrowsing session.

As illustrated in FIG. 3C, a user interface 366 may display a rendered HTML format version of an uploaded document in a modal window 340. The rendered HTML format version of the uploaded document may be displayed in the modal window 340 after a process of uploading a document from the user device to share in the cobrowsing session in a converted format. In some embodiments, the rendered HTML format version may appear in the browser window 308 as opposed to the modal window 340. In some embodiments, the modal window 340 may totally or partially obscure a view of the browser window 308. The modal window 340 may be moveable by one or more participants of the cobrowsing session.

When a user uploads a document or navigates to a webpage to be shared in a cobrowsing session, the user may be presented with a preview mode user interface 369 as illustrated in FIG. 3D. The preview mode user interface 369 may include a viewing mode indicator 370 which may inform the user that he or she is viewing the document or webpage in a preview mode.

In the preview mode, the document or webpage to be shared may be displayed in its own window 371. The preview mode user interface 369 may be displayed on a user device of the user choosing to share the document or webpage or may be displayed on user devices of group members of a group to which the sharing user belongs. Other permission level settings may adjust which users may see the unedited document or webpage in the preview mode before the document or webpage is shared.

Once a webpage or document is selected to be shared, a process of automatically identifying potentially sensitive information may begin. The process may involve segmenting the document or webpage into portions and inputting each portion into a neural network, for example a convolutional neural network. The neural network may be trained to identify portions containing sensitive data.

After the process of automatically identifying potentially sensitive information, an analysis results mode user interface 372 may be presented to the sharing user as illustrated in FIG. 3E. In the analysis results mode user interface 372, a viewing mode indicator 370 may inform a user that he or she is viewing the document or webpage in an analysis results mode.

A GUI box 383 may be displayed within the analysis results mode user interface enabling a user to review what content has been marked as sensitive and to be blocked by the AI system. The box 383 may enable a user to select or deselect the content to be blocked. For example, the box 383 may allow a user to select content identified by the AI system and instruct the application not to block the selected content. In some embodiments, the portions selected as to be blocked by the AI system may be highlighted. Highlighting may take the form of boxes 374, 375. To adjust the amount of data being censored, a user may be capable of using a cursor to manually move edges of the boxes 374, 375.

An edit tools window 373 as illustrated in FIGS. 3E-G may comprise a number of GUI buttons including, for example, a text select button, a snip tool, a block selection button, an unblock selection button, an accept and continue button, etc.

After either approving or disapproving of the automatically identified portions, the user seeking to share the document or webpage may be presented with a user edit user interface 376. as illustrated in FIG. 3F. The user edit user interface 376 may include a viewing mode indicator 370 to inform the user that he or she is viewing the document or webpage in a user edit mode.

Using edit tools, a user viewing the user interface 376 may be enabled to select additional content to be censored. For example, a user may be capable of drawing a box 377 to highlight material to be blocked.

After accepting the portions identified as to be blocked, the user may enter a final preview mode user interface 378 as illustrated in FIG. 3G. The final preview mode user interface 378 may include a viewing mode indicator 370 to inform the user that he or she is viewing the document or webpage in a preview mode.

Content that has been marked for being blocked may be masked out such that it is not viewable. For example, a white mask with no edges 379 which is not visible to users viewing the cobrowsing session may be placed over the blocked content. In some embodiments, black boxes, blurred areas, or other forms of obscuration may be used.

Using the edit tools, a user viewing the preview mode user interface 378 may be capable of accepting the censoring or of making additional changes before moving on. For example, the white masks, black boxes, etc. may be capable of being moved around the user interface and/or resized, removed, etc.

Upon accepting the masking in the final preview mode user interface 378, a user interface 380 may show the shared document or webpage with the masked masking the blocked content to all users participating in the cobrowsing session as illustrated in FIG. 3H.

In some embodiments, using edit tools, a user viewing a user edit mode user interface 381 may be enabled to select content the user does not want to be censored as illustrated in FIG. 3I. For example, a user may be capable of drawing a box 382 to highlight material which should not be blocked. As can be appreciated, the box 382 may result in the same result as the box 377 illustrated in FIG. 3F.

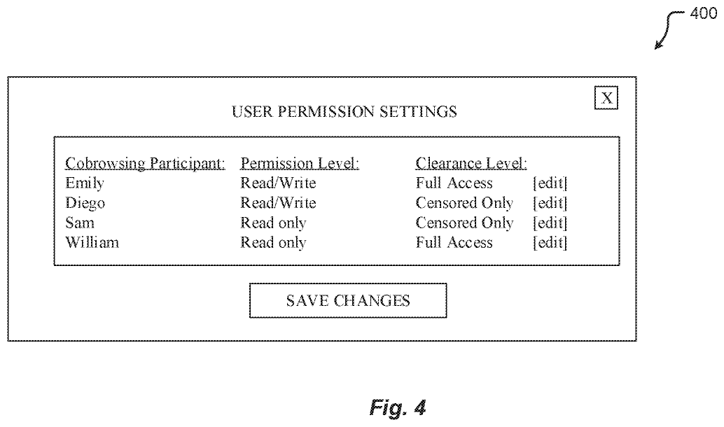

As illustrated in FIG. 4, a user permission settings GUI element 400 may be used to set permissions for participants of the cobrowsing session. For each document shared in a cobrowsing session, each participant may have a permission level associated with the document. For example, a participant may have read only or read/write permission for a given document. If the participant has read only permissions for a document, the participant may be enabled to view the document in the cobrowsing session while a participant with read/write permissions may be capable of viewing and editing the document. A clearance level permission setting may be used to adjust which users may see content labeled as sensitive. For example, a user may have full access and may be capable of seeing content despite a mask. Other users may be limited to seeing only censored content as masked. The clearance level permission setting may also be used to adjust which users may participate in the labelling of sensitive information in a webpage or document. In some embodiments, users may be linked together as teams or groups to allow users to mark sensitive information together. Using a user permission settings GUI element 400, a user may be capable of adjusting and/or otherwise editing permissions for other users. In some embodiments, only the user who has uploaded the document may adjust the permissions. In other embodiments, any user with read/write permission may adjust the permissions. It should be appreciated that other configurations may be implemented.

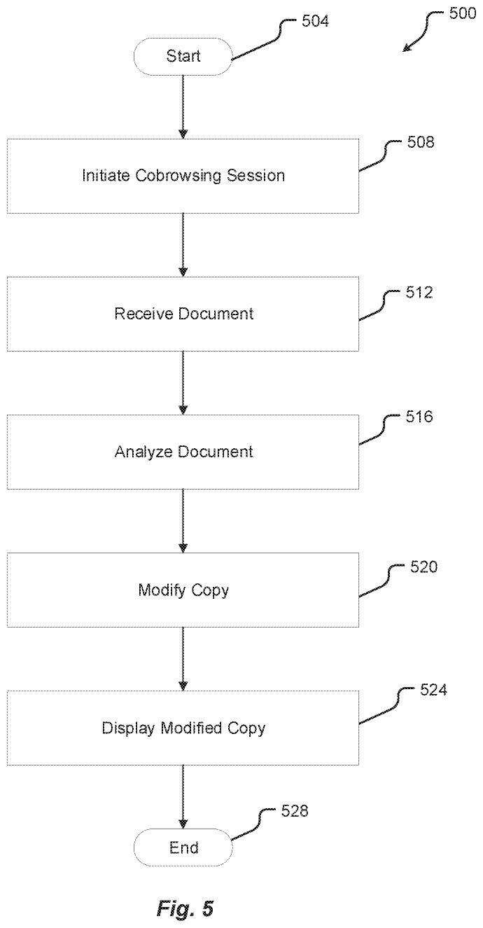

In some embodiments, the systems and methods described herein may be executed on one or a combination of a cobrowsing server, a webserver, or a user device. FIGS. 5-7 are flow diagrams of processes of browsers executing cobrowsing sessions. Browsers executing on user devices may display GUI elements and may be in communication with one or more other user devices, one or more cobrowsing servers, and/or one or more webservers via a network location. The methods described herein and illustrated by the flow diagrams of FIGS. 5-7 may be executed by processors or microprocessors of computer devices which may perform the methods. The processes described herein may be performed by executing program instructions stored in a computer readable storage medium such as a memory device. Although the methods described in relation with FIGS. 5-7 are shown in a specific order, one of skill in the art would recognize that the steps in FIGS. 5-7 may be implemented in different orders and/or be implemented in a multi-threaded environment. Moreover, various steps may be omitted, added, or repeated based on implementation.

The process 500 of FIG. 5 is from a perspective of a computer application executing a cobrowsing session. The process 500 starts in step 504 in which a user device capable of executing a browser application is used by a user to join a cobrowsing session. In some embodiments, such a cobrowsing session may be hosted by a user device or in some embodiments a cobrowsing server or webserver. The cobrowsing session may be accessed by a plurality of cobrowsing participants. Each participant may view the same or a similar view in a GUI displayed on his or her user device.

In step 508, the cobrowsing session may be initiated. Initiating the cobrowsing session may comprise the user creating a new cobrowsing session or joining an existing cobrowsing session. Step 508 may be triggered by a request from the user of the user device. For example, the user may click a hyperlink which may activate a JavaScript application executing in his or her browser to one of join an existing cobrowsing session or create a new cobrowsing session.

In step 512, a participant of the cobrowsing session may select a document or webpage to be shared using a user interface of a cobrowsing application executing on a user device used by the participant. The document or webpage may be received by one or more of the user device used by the participant or by a cobrowsing hosting computer system such as a server.

In step 516, the document or webpage may be analyzed by the receiving user device or computer system. For example, the document or webpage may be segmented into portions and each portion may be input into a neural network such as a convolutional neural network. The neural network may output portions identified as containing sensitive information. Such output portions identified as containing sensitive information may be presented to a user participant of the co-browsing application seeking to share the document.

In step 520, a copy of the document may be modified such that portions of the document identified as containing sensitive information may be censored, blocked, obscured, or otherwise removed from display.

In step 524, the modified copy of the document may be displayed within the co-browsing session. The process 500 ends at step 528. At the end of the process 500, the cobrowsing session may continue with each participant being enabled to view the shared masked webpage or document on his or her user device. For example, the shared document may be displayed in a modal window within the cobrowsing application executing within a browser on the user device. Each user may be capable of editing the document within the cobrowsing session based on his or her permission levels set within the cobrowsing application for the session.

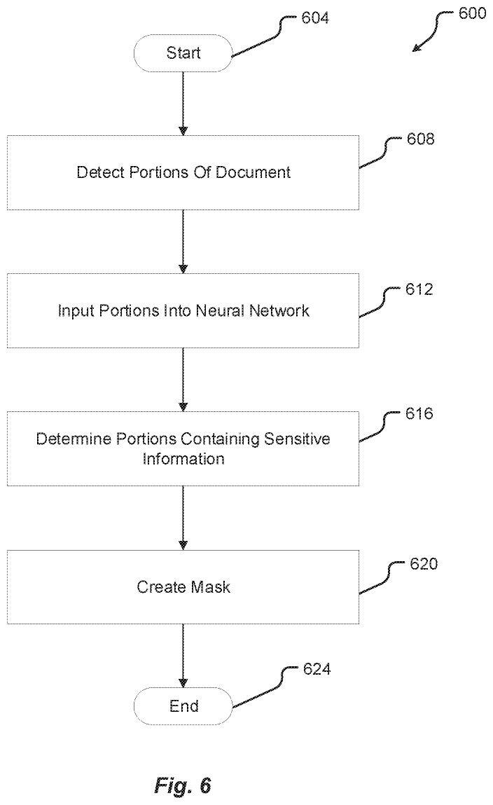

The process 600 of FIG. 6 is from a perspective of a computer application executing a cobrowsing session. The process 600 may take place during a cobrowsing session in which one or more users of user devices are participating. The process 600 starts in step 604 in which a computer system hosting a cobrowsing session receives a webpage or document to be shared in the cobrowsing session. For example, and as discussed herein, the computer system hosting the cobrowsing session may receive such a webpage or document as a result of a user requesting to share the document, locating the document on the user's user device, and uploading the document into the cobrowsing application executing in a browser. In some embodiments, the process may begin upon a user navigating to a webpage.

In step 608, portions of a document to be shared in the co-browsing session may be detected. For example, distinct text blocks may be identified to be portions of a document. In some embodiments, documents may be segmented into a plurality of portions.

In step 612, the portions of the document to be shared identified in step 608 may be input into a neural network. As described herein, the neural network may process each portion individually to identify whether or not the portion contains sensitive or potentially sensitive information. The neural network may output an indication as to whether each portion contains sensitive information or potentially contain sensitive information.

In step 616, the indication as to whether each portion contains sensitive information or potentially contains sensitive information output by the neural network may be used to determine the portions of the document to be shared which contain sensitive information. Additionally, user input may also be used to determine additional portions containing sensitive information and also may be used to select portions identified by the neural network as containing sensitive information which do not in fact include such sensitive information.

In step 620, a mask may be created. The mask may be created by the co-browsing application executing on the user's user device. The created mask may be designed such as to obscure the portions identified as containing sensitive information in step 616. In some embodiments the mask may be an SVG file. The mask may be used to modify a copy of the document to be shared such that the portions identified as containing sensitive information in step 616 are obscured. The process 600 ends at step 624 at which point the users participating in the session may view and/or edit the webpage or document while continuing the cobrowsing session.

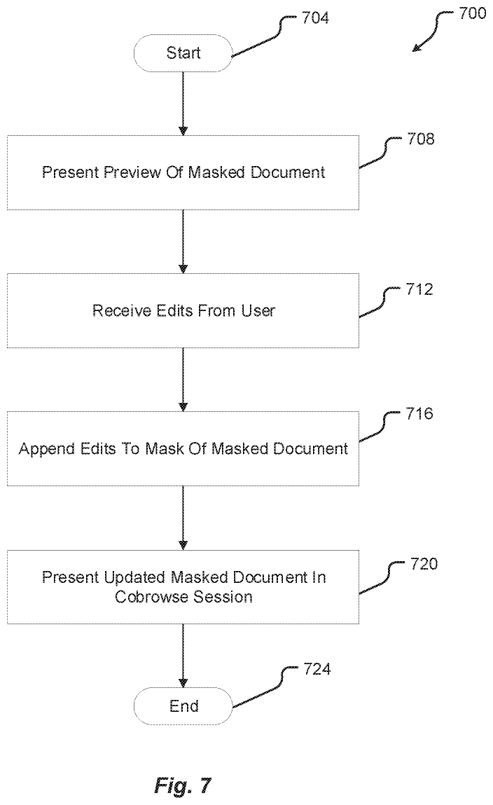

The process 700 of FIG. 7 is from a perspective of a computer application executing in association with a cobrowsing session. The process 700 starts in step 704 in which a computer system is hosting a cobrowsing session and a user seeking to share a document or webpage has identified the document or webpage and the document or webpage to be shared has been analyzed and/or edited by the user to identify portions of the document or webpage to be shared which contain sensitive or potentially sensitive information.

In step 708, a preview of a masked version of the document may be presented to the user seeking to share the document. At this point, the user may be capable of reviewing and or editing the master version of the document.

In step 712, the co-browsing application may receive one or more edits to the masked version of the document from the user. For example, the user may edit the document as discussed above in relation to FIGS. 3A-3I.

In step 716, the co-browsing application may append the received edits to the masked version of the document to create an updated version of the masked document to be shared

In step 720, the updated masked document may be presented to the other participants in the cobrowsing session.

The process 700 ends at step 724 at which point the cobrowsing session may continue. The process 700 may also take place at the end of cobrowsing sessions. Following the process 700, the cobrowsing session may continue or may end.

Any of the steps, functions, and operations discussed herein can be performed continuously and automatically.

The exemplary systems and methods of this disclosure have been described in relation to cobrowsing software applications. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a computer-implemented method for automatically censoring sensitive data from a shared document in a collaborative document-sharing session, certain embodiments of the method may comprise: receiving, by a processor of a computer system executing an application participating in the collaborative document-sharing session, a document to upload to the session; analyzing, by the processor, a plurality of portions of the document; based on the analysis of the plurality of portions, identifying, by the processor, a first one or more of the portions of the document containing sensitive information; modifying, by the processor, a copy of the document to block the first one or more of the portions of the document containing sensitive information; and displaying, by the processor, the modified copy of the document in the collaborative document-sharing session.

Aspects of the above method may further comprise wherein analyzing contents of the document comprises inputting the plurality of portions of the document into a neural network.

Aspects of the above method may further comprise wherein the neural network outputs a group of the portions of the document identified as containing sensitive information.

Aspects of the above method may further comprise wherein prior to displaying the modified copy, the processor displays a preview of the modified copy of the document on a display device of the computer system.

Aspects of the above method may further comprise wherein after displaying the preview of the modified copy, the processor waits for feedback before displaying the modified copy of the document.

Aspects of the above method may further comprise wherein the neural network is trained based on the feedback.

Aspects of the above method may further comprise wherein the feedback comprises a disapproval of one or more of the one or more of the portions of the document containing sensitive information.

Aspects of the above method may further comprise modifying, by the processor, the modified copy to unblock the disapproved one or more of the one or more portions of the document containing sensitive information.

Aspects of the above method may further comprise wherein the feedback comprises an indication of a second one or more of the portions of the document, wherein each of the second one or more of the portions of the document are not contained in the first one or more of the portions of the document containing sensitive information.

Aspects of the above method may further comprise wherein the second one or more of the portions of the document are added to the first one or more of the portions of the document.

Aspects of the above method may further comprise wherein modifying the copy of the document comprises adding a mask to the document.

Aspects of the above method may further comprise wherein the mask is in an SVG format.

Aspects of the above method may further comprise wherein the document is a webpage.

Embodiments include a computer system comprising: a processor; and a computer-readable storage medium storing computer-readable instructions, which when executed by the processor, cause the processor to: execute an application participating in a collaborative document-sharing session; receive a document to upload to the session; analyze a plurality of portions of the document; based on the analysis of the plurality of portions, identify a first one or more of the portions of the document containing sensitive information; modify a copy of the document to block the first one or more of the portions of the document containing sensitive information; and display the modified copy of the document in the collaborative document-sharing session.

Aspects of the above system may further comprise wherein analyzing contents of the document comprises inputting the plurality of portions of the document into a neural network.

Aspects of the above system may further comprise wherein the neural network outputs a group of the portions of the document identified as containing sensitive information.

Aspects of the above system may further comprise wherein prior to displaying the modified copy, the processor displays a preview of the modified copy of the document on a display device of the computer system.

Aspects of the above system may further comprise wherein after displaying the preview of the modified copy, the processor waits for feedback before displaying the modified copy of the document.

Aspects of the above system may further comprise wherein the neural network is trained based on the feedback.

Aspects of the above system may further comprise wherein the feedback comprises a disapproval of one or more of the one or more of the portions of the document containing sensitive information.

Aspects of the above system may further comprise modifying, by the processor, the modified copy to unblock the disapproved one or more of the one or more portions of the document containing sensitive information.

Aspects of the above system may further comprise wherein the feedback comprises an indication of a second one or more of the portions of the document, wherein each of the second one or more of the portions of the document are not contained in the first one or more of the portions of the document containing sensitive information.

Aspects of the above system may further comprise wherein the second one or more of the portions of the document are added to the first one or more of the portions of the document.

Aspects of the above system may further comprise wherein modifying the copy of the document comprises adding a mask to the document.

Aspects of the above system may further comprise wherein the mask is in an SVG format.

Aspects of the above system may further comprise wherein the document is a webpage.

Embodiments include a computer program product comprising: a computer-readable storage medium having computer-readable program code embodied therewith, the computer-readable program code configured, when executed by a processor, to: execute an application participating in a collaborative document-sharing session; receive a document to upload to the session; analyze a plurality of portions of the document; based on the analysis of the plurality of portions, identify a first one or more of the portions of the document containing sensitive information; modify a copy of the document to block the first one or more of the portions of the document containing sensitive information; and display the modified copy of the document in the collaborative document-sharing session.

Aspects of the above computer program product may further comprise wherein analyzing contents of the document comprises inputting the plurality of portions of the document into a neural network.

Aspects of the above computer program product may further comprise wherein the neural network outputs a group of the portions of the document identified as containing sensitive information.

Aspects of the above computer program product may further comprise wherein prior to displaying the modified copy, the processor displays a preview of the modified copy of the document on a display device of the computer system.

Aspects of the above computer program product may further comprise wherein after displaying the preview of the modified copy, the processor waits for feedback before displaying the modified copy of the document.

Aspects of the above computer program product may further comprise wherein the neural network is trained based on the feedback.

Aspects of the above computer program product may further comprise wherein the feedback comprises a disapproval of one or more of the one or more of the portions of the document containing sensitive information.

Aspects of the above computer program product may further comprise modifying, by the processor, the modified copy to unblock the disapproved one or more of the one or more portions of the document containing sensitive information.

Aspects of the above computer program product may further comprise wherein the feedback comprises an indication of a second one or more of the portions of the document, wherein each of the second one or more of the portions of the document are not contained in the first one or more of the portions of the document containing sensitive information.

Aspects of the above computer program product may further comprise wherein the second one or more of the portions of the document are added to the first one or more of the portions of the document.

Aspects of the above computer program product may further comprise wherein modifying the copy of the document comprises adding a mask to the document.

Aspects of the above computer program product may further comprise wherein the mask is in an SVG format.

Aspects of the above computer program product may further comprise wherein the document is a webpage.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A method for automatically censoring sensitive data from a shared document in a collaborative document-sharing session, the method comprising:
receiving, by a processor of a computer system executing an application participating in the collaborative document-sharing session, a document to upload to the collaborative document-sharing session;
analyzing, by the processor, a plurality of portions of the document;
based on the analysis of the plurality of portions, identifying, by the processor, a first one or more of the portions of the document containing sensitive information;
modifying, by the processor, a copy of the document to block the first one or more of the portions of the document containing sensitive information; and
displaying, by the processor, the modified copy of the document in the collaborative document-sharing session.

2. The method of claim 1, wherein analyzing contents of the document comprises inputting the plurality of portions of the document into a neural network.

3. The method of claim 2, wherein the neural network outputs a group of the portions of the document identified as containing sensitive information.

4. The method of claim 2, wherein prior to displaying the modified copy of the document, the processor displays a preview of the modified copy of the document on a display device of the computer system.

5. The method of claim 4, wherein after displaying the preview of the modified copy of the document, the processor waits for feedback before displaying the modified copy of the document.

6. The method of claim 5, wherein the neural network is trained based on the feedback.

7. The method of claim 5, wherein the feedback comprises a disapproval of one or more of the one or more of the portions of the document containing sensitive information.

8. The method of claim 7, further comprising modifying, by the processor, the modified copy of the document to unblock the disapproved portions of the document containing sensitive information.

9. The method of claim 5, wherein the feedback comprises an indication of a second one or more of the portions of the document, wherein each of the second one or more of the portions of the document are not contained in the first one or more of the portions of the document containing sensitive information.

10. The method of claim 9, wherein the second one or more of the portions of the document are added to the first one or more of the portions of the document.

11. The method of claim 1, wherein modifying the copy of the document comprises adding a mask to the document.

12. The method of claim 11, wherein the mask is in an SVG format.

13. The method of claim 1, wherein the document is a webpage.

14. A computer system comprising:
a processor; and
a computer-readable storage medium storing computer-readable instructions, which when executed by the processor, cause the processor to:
execute an application participating in a collaborative document-sharing session;
receive a document to upload to the collaborative document-sharing session;
analyze a plurality of portions of the document;
based on the analysis of the plurality of portions, identify a first one or more of the portions of the document containing sensitive information;
modify a copy of the document to block the first one or more of the portions of the document containing sensitive information; and
display the modified copy of the document in the collaborative document-sharing session.

15. The computer system of claim 14, wherein analyzing contents of the document comprises inputting the plurality of portions of the document into a neural network.

16. The computer system of claim 15, wherein the neural network outputs a group of the portions of the document identified as containing sensitive information.

17. The computer system of claim 15, wherein prior to displaying the modified copy of the document, the processor displays a preview of the modified copy of the document on a display device of the computer system.

18. The computer system of claim 17, wherein after displaying the preview of the modified copy of the document, the processor waits for feedback before displaying the modified copy of the document.

19. The computer system of claim 18, wherein the neural network is trained based on the feedback.

20. A computer program product comprising:
a computer-readable storage medium having computer-readable program code embodied therewith, the computer-readable program code configured, when executed by a processor, to:
execute an application participating in a collaborative document-sharing session;
receive a document to upload to the collaborative document-sharing session;
analyze a plurality of portions of the document;
based on the analysis of the plurality of portions, identify a first one or more of the portions of the document containing sensitive information;
modify a copy of the document to block the first one or more of the portions of the document containing sensitive information; and
display the modified copy of the document in the collaborative document-sharing session.
